(19) United States
(12) Patent Application Publication
(10) Pub. No.: US 2026/0052301 A1
(43) Pub. Date: Feb. 19, 2026

(54) ELECTRONIC APPARATUS, INFORMATION PROCESSING DEVICE, METHOD OF CONTROLLING ELECTRONIC APPARATUS, AND NON-TRANSITORY COMPUTER READABLE MEDIUM

(71) Applicant: CANON KABUSHIKI KAISHA, TOKYO (JP)

(72) Inventors: TAKAMITSU ABE, TOKYO (JP); YUKI CHISHIMA, KANAGAWA (JP)

(21) Appl. No.: 19/291,972

(22) Filed: Aug. 6, 2025

(30) Foreign Application Priority Data
Aug. 13, 2024 (JP) 2024-134867

(51) Int. Cl. H04N 23/51; G03B 17/56

(52) U.S. Cl. CPC H04N 23/51; G03B 17/566

(57) ABSTRACT

An electronic apparatus, including a plurality of accessory shoes on each of which an accessory is mountable, the accessory being capable of being mounted on the accessory shoe of a first device, executes a connection detection process to detect mounting of an accessory, and executes a control process to, in a case where it is detected that an accessory has been mounted in the connection detection process, transmit, to the first device, information including a type of a mounted accessory and first port information indicating the accessory shoe on which the mounted accessory is mounted, and in a case where a communication command appended with second port information indicating an accessory shoe to be used for communication is received from the first device, transmit the communication command, from which the second port information is deleted, to the accessory mounted on the accessory shoe.

### BACKGROUND

### Field of the Technology

The present disclosure relates to electronic apparatus, information processing device, method of controlling electronic apparatus, and non-transitory computer readable medium.

### Description of the Related Art

Conventionally, there is a system in which an accessory (such as a flash) is mounted on an accessory shoe provided on an imaging device such as a camera. The accessory shoe is provided with a plurality of contacts (terminals) for supplying power to the accessory or for communicating with the accessory. When an accessory having a communication function is mounted on an imaging device, the imaging device and the accessory are linked in synchronization through communication with each other. Japanese Patent Laid-Open No. 2021-167942 discloses an accessory shoe for an imaging device having a plurality of communication terminals.

Japanese Patent Laid-Open No. 2021-167942 assumes that one accessory is connected to the imaging device. For this reason, when attempting to operate the plurality of accessories from the imaging device via an electronic apparatus that allows connection of the plurality of accessories, communication errors may occur. Specifically, an I2C (Inter-Integrated Circuit) signal is used to communicate from a master imaging device to a slave accessory by specifying a communication address, but accessories of the same type have the same communication address. Therefore, when an electronic apparatus that allows connection of the plurality of accessories is mounted on an imaging device and when two identical accessories are connected to the electronic apparatus, the imaging device cannot communicate with each of the accessories.

### SUMMARY

The present disclosure provides a technology that allows a device to communicate with each of a plurality of accessories via an electronic apparatus that allows the plurality of accessories to be connected to the device.

The present disclosure in its one aspect provides an electronic apparatus including an adapter connectable to an accessory shoe of a first device, a plurality of accessory shoes on each of which an accessory is mountable, the accessory being capable of being mounted on the accessory shoe of the first device, a processor, and a memory storing a program which, when executed by the processor, causes the electronic apparatus to execute a connection detection process of detecting that an accessory has been mounted on at least one of the plurality of accessory shoes, and execute a control process of performing communication control to, in a case where it is detected that an accessory has been mounted in the connection detection process, transmit, to the first device, information including a type of a mounted accessory which is the accessory mounted on at least any of the plurality of accessory shoes and first port information indicating the accessory shoe on which the mounted accessory is mounted, and in a case where a communication command to which second port information indicating an accessory shoe to be used for communication is appended is received from the first device, transmit the communication command, from which the second port information is deleted, to the accessory mounted on the accessory shoe indicated by the second port information.

Features of the present disclosure will become apparent from the following description of embodiments with reference to the attached drawings. The following description of embodiments is described by way of example.

### BRIEF DESCRIPTION OF THE DRAWINGS

FIG. 1 is a diagram illustrating a system according to a first embodiment.

FIG. 2A is a diagram illustrating a communication configuration of an electronic apparatus according to the first embodiment with a switch in an OFF state.

FIG. 2B is a diagram illustrating a communication configuration of an electronic apparatus according to the first embodiment with a switch in an ON state.

FIG. 3 is a flowchart of overall processing according to the first embodiment.

FIG. 4 is a flowchart of overall processing according to a first modified example.

FIG. 5 is a flowchart of overall processing according to a second modified example.

### DESCRIPTION OF THE EMBODIMENTS

Embodiments of the present disclosure will be described below in detail with reference to the accompanying drawings.

### First Embodiment

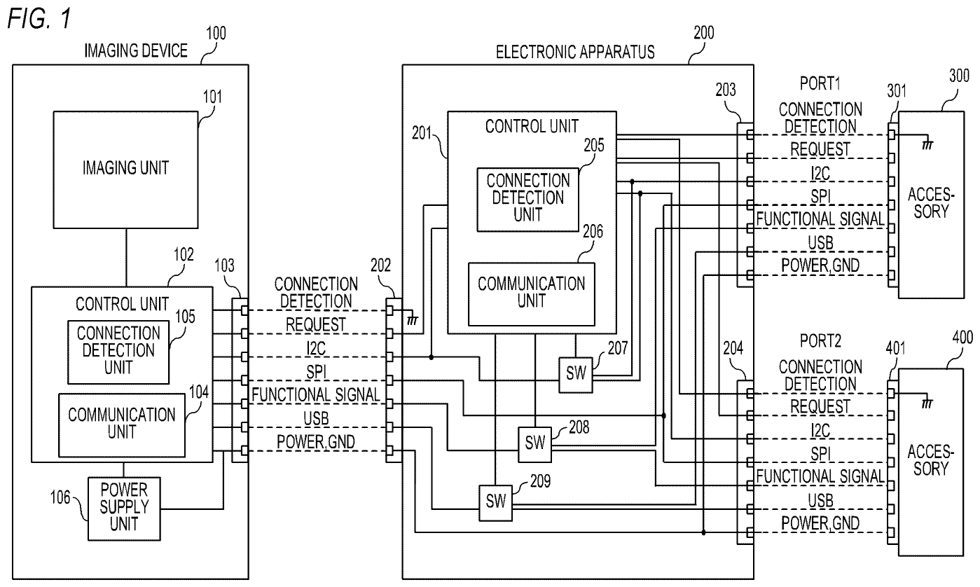

FIG. 1 is a diagram illustrating a system according to the first embodiment. The system includes an imaging device 100, an electronic apparatus 200, an accessory 300, and an accessory 400. The imaging device 100 is an electronic apparatus (such as a digital camera or a video camera) that captures an image of a subject to obtain an image. Note that instead of the imaging device 100, any information processing device (electronic apparatus) on which an accessory can be mounted may be used.

The imaging device 100 has an imaging unit 101, a control unit 102, an accessory shoe 103, and a power supply unit 106. The control unit 102 has a communication unit 104 and a connection detection unit 105.

The imaging unit 101 captures an image of a subject to obtain an image. The imaging unit 101 has an image sensor.

The control unit 102 controls each component of the imaging device 100.

The accessory shoe 103 is a connection unit on which an accessory compatible with the imaging device 100 can be mounted (attached).

The communication unit 104 performs I2C communication with the accessory mounted on the accessory shoe 103.

The connection detection unit 105 detects whether an accessory is mounted on the accessory shoe 103.

The power supply unit 106 supplies power to the imaging device 100 or to an accessory connected via the accessory shoe 103.

The electronic apparatus 200 connects to the imaging device 100. The electronic apparatus 200 is an accessory for the imaging device 100 that enables the use of a plurality of accessories. The electronic apparatus 200 has a control unit 201, a connection unit 202, an accessory shoe 203, an accessory shoe 204, a switch 207, a switch 208, and a switch 209. The control unit 201 has a connection detection unit 205 and a communication unit 206.

The control unit 201 controls each component of the electronic apparatus 200.

The connection unit 202 connects to the accessory shoe 103 of the imaging device 100.

The accessory shoe 203 and the accessory shoe 204 are each an accessory shoe on which an accessory (an accessory that can be mounted on the imaging device 100) can be mounted. The accessory shoe 203 and the accessory shoe 204 each have the same shape as the accessory shoe 103 of the imaging device 100.

The connection detection unit 205 detects whether an accessory is mounted on either the accessory shoe 203 or the accessory shoe 204.

The communication unit 206 performs I2C communication with devices other than the electronic apparatus 200 (the imaging device 100, the accessory 300, and the accessory 400).

The switch 207 switches the connection destination of an I2C signal. The switch 208 switches the connection destination of a function signal. The switch 209 switches the connection destination of a USB (Universal Serial Bus) signal.

The accessory 300 is an accessory that can be mounted on the imaging device 100. The connection unit 301 of the accessory 300 connects to the accessory shoe 203 of the electronic apparatus 200.

The accessory 400 is an accessory that can be mounted on the imaging device 100. The connection unit 401 of the accessory 400 connects to the accessory shoe 204 of the electronic apparatus 200. The accessory 300 and the accessory 400 may be, for example, a strobe, a microphone, a video light, a smartphone holder, a display device, or an external memory.

In FIG. 1, the electronic apparatus 200 is mounted on the imaging device 100, and the accessory 300 and the accessory 400 are mounted on the electronic apparatus 200. However, the number of accessories mounted on the electronic apparatus 200 may be equal to or greater than three. Note that, in the following, the accessory shoe of the electronic apparatus 200 has a port number. The port of the accessory shoe 203 is called “port 1,” and the port of the accessory shoe 204 is called “port 2.”

Each of the accessory shoes 103, 203, and 204 and the connection units 202, 301, and 401 has a plurality of connection terminals. The plurality of terminals here refers to a “connection detection terminal,” a “request terminal,” an “I2C terminal,” a “SPI (Serial Peripheral Interface) terminal,” a “function signal terminal,” a “USB terminal,” and a “power and GND terminal.”

The connection detection terminal is a terminal that detects whether an accessory is mounted on an accessory shoe. For example, when detecting a connection between the imaging device 100 and the electronic apparatus 200, the electronic apparatus 200 is connected to GND, and the imaging device 100 determines that the connection has been established upon detecting that the pulled-up port has fallen to a LOW level. When detecting a connection between the electronic apparatus 200 and an accessory (accessory 300, 400), the accessory is connected to GND, and the electronic apparatus 200 determines that the connection has been established upon detecting that the pulled-up port has fallen to a LOW level.

The request terminal is a terminal that requests communication from the accessory (accessory 300, 400) to the imaging device 100. Communication between the imaging device 100 and the accessory (accessory 300, 400) is basically started by the imaging device 100. For this reason, when a communication is requested from the accessory, the communication request is transmitted via a signal from the request terminal. In the configuration of FIG. 1, when the electronic apparatus 200 is mounted on the imaging device 100, the imaging device 100 can detect the connection of the electronic apparatus 200, but cannot determine whether an accessory is connected to the electronic apparatus 200. In such a case, the electronic apparatus 200 issues a request to the imaging device 100 using the request terminal, and the imaging device 100 can acquire information about the electronic apparatus 200 through communication.

The I2C terminal is a terminal for transmitting and receiving I2C signals. The I2C terminal is composed of a clock (SCL) terminal and a data input/output (SDA) terminal, and exchanges accessory type information. In communication between the imaging device 100 and the electronic apparatus 200, the imaging device 100 serves as the master side, and the electronic apparatus 200 serves as the slave side. The imaging device 100, which is the master side, specifies a slave address to realize communication.

The SPI terminal is a terminal for transmitting and receiving SPI signals. The function signal terminal is a terminal for transmitting and receiving “signals whose assigned functions change depending on the accessory.” The USB terminal is a terminal for transmitting and receiving USB communication. The power and GND terminals are terminals for supplying power to drive the accessories.

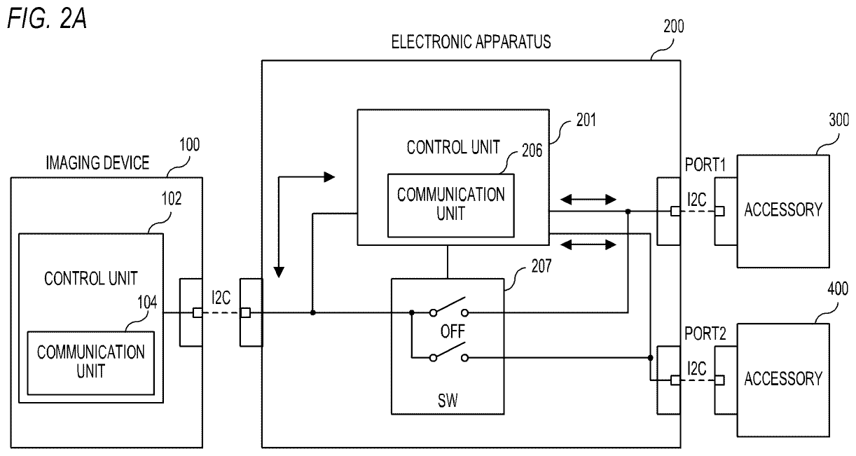

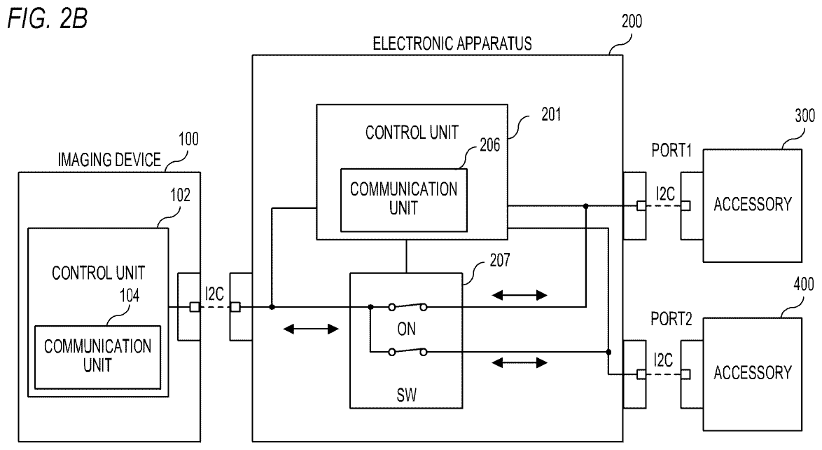

FIGS. 2A and 2B are block diagrams showing the communication configuration of the electronic apparatus 200 according to the first embodiment.

In FIG. 2A, the switch 207 that controls the I2C signal is in an OFF state. When the switch 207 is in an OFF state, the control unit 201 of the electronic apparatus 200 relays (controls) communication between the imaging device 100 and each accessory (accessories 300, 400). In this way, when direct communication (communication that does not depend on the control of the control unit 201) between the imaging device 100 and each accessory is not possible, the control unit 201 of the electronic apparatus 200 coordinates the communication according to the configuration of FIG. 2A. This allows the imaging device 100 to communicate with each accessory.

In FIG. 2B, the switch 207 that controls the I2C signal is in an ON state, and direct communication (communication that does not depend on the control by the control unit 201) is performed between the imaging device 100 and each accessory (accessories 300, 400) via I2C signals. When the switch 207 is in an ON state, if the imaging device 100 transmits an I2C signal to the electronic apparatus 200, the I2C signal is transmitted to all accessories mounted on the electronic apparatus 200. Even when the same I2C signal is transmitted to a plurality of accessories, each accessory can determine whether the I2C signal is addressed to itself or to another by referring to the communication address included in the I2C signal. When direct communication between the imaging device 100 and each accessory is possible, the configuration of FIG. 2B enables the response speed of communication between the imaging device 100 and each accessory to be faster than in the case of relayed communication (in the case of FIG. 2A). The configuration of FIG. 2B is particularly effective when controlling an accessory that requires a fast communication response speed.

### Overall Processing

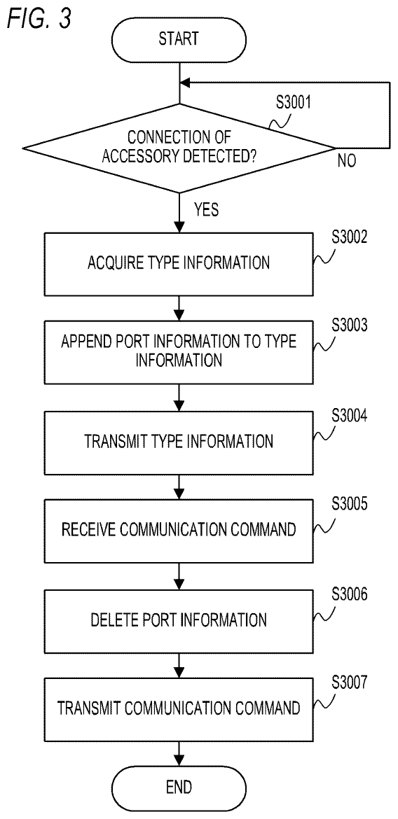

The overall processing according to the first embodiment will be described with reference to the flowchart of FIG. 3.

Here, the following processing will be described with reference to the flowchart of FIG. 3. Specifically, when the control unit 201 detects that an accessory is connected, it transmits port information on the port to which the accessory is connected and type information of the accessory to the imaging device 100. In addition, when the control unit 201 acquires a communication command with appended port information from the imaging device 100, it transmits the communication command with the acquired port information deleted to the accessory mounted on the port corresponding to the port information.

In step S3001, the connection detection unit 205 monitors the connection at port 1 (accessory shoe 203) and port 2 (accessory shoe 204) to determine whether an accessory is mounted (connection is detected) on at least one of the ports. If it is determined that no accessory is mounted on cither port 1 or port 2, the processing of step S3001 is repeated. If it is determined that an accessory is mounted on at least one of port 1 and port 2, the processing proceeds to step S3002. Subsequent processing is performed for the port on which the accessory is mounted (hereinafter referred to as the “connected port”). In the following description, it is assumed that the connected port is port 1.

In step S3002, the communication unit 206 communicates with the accessory mounted on the connected port (hereinafter referred to as the “mounted accessory”) to obtain type information of the mounted accessory. The type information includes, for example, the type, model number, serial number, and power consumption information (such as information on maximum power consumption) of the accessory.

In step S3003, the control unit 201 appends port information to the type information of the mounted accessory. The port information is information indicating the connected port (accessory shoe) of the electronic apparatus 200, on which the mounted accessory is mounted. Here, the port information is information indicating port 1.

In step S3004, the communication unit 206 transmits the type information of the mounted accessory to which the port information is appended to the imaging device 100. As a result, the communication unit 206 notifies the imaging device 100 of the connected port by transmitting the port information. Therefore, the imaging device 100 can recognize the port (accessory shoe) of the electronic apparatus 200, on which the accessory is mounted.

In step S3005, the communication unit 206 receives a communication command with appended port information from the imaging device 100. Here, if the mounted accessory is directly mounted on the imaging device 100, the port information is not necessary. However, since a plurality of accessories can be connected to the imaging device 100 via the electronic apparatus 200, the imaging device 100 needs to specify the accessory to communicate with by specifying the port of the electronic apparatus 200. Therefore, the imaging device 100 allows the electronic apparatus 200 to recognize the accessory with which the imaging device 100 will communicate (the accessory shoe used for communication by the imaging device 100) by transmitting a communication command with appended port information.

In step S3006, the control unit 201 deletes the port information from the communication command. Here, one imaging device 100 is connected to one accessory. For this reason, the accessory does not require port information and does not receive communication commands that include port information.

In step S3007, the control unit 201 transmits a communication command to the mounted accessory (here, accessory 300) via the connected port (here, port 1). This allows the imaging device 100 to communicate with the accessory 300 via the electronic apparatus 200.

In the first embodiment, the electronic apparatus 200 notifies the imaging device 100 of the connected port using the port information. This allows the imaging device 100 to recognize the port (accessory shoe) of the electronic apparatus 200, on which the accessory is mounted. In addition, since the port information is included in the communication command from the imaging device 100, the electronic apparatus 200 can recognize the accessory with which the imaging device 100 communicates via the electronic apparatus 200. Therefore, even if a plurality of accessories can be connected to the imaging device 100 via the electronic apparatus 200, each accessory and the imaging device 100 can communicate more appropriately.

### First Modified Example

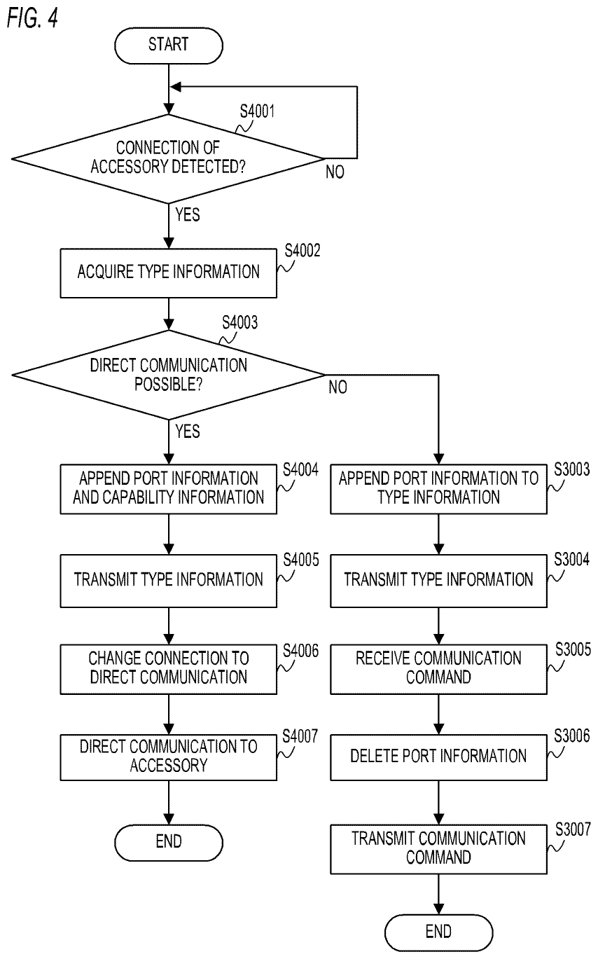

In the first modified example, the control unit 201 determines the type of the mounted accessory, and when it determines that the imaging device 100 can directly communicate with the mounted accessory, it connects the imaging device 100 and the mounted accessory so that they can communicate directly. The phrase “when the imaging device 100 can directly communicate with the mounted accessory” refers to a case where the mounted accessory and the imaging device 100 can communicate with each other without the control unit 201 intervening between the connection unit 202 and ports 1 and 2 as shown in FIG. 2B. “When the imaging device 100 can directly communicate with the mounted accessory,” the imaging device 100 and the mounted accessory can communicate using I2C signals without the electronic apparatus 200 performing a process (communication control process) of transmitting the communication command after deleting port information therefrom. The processing of the electronic apparatus 200 according to the first modified example will be described with reference to the flowchart of FIG. 4.

Step S4001 is the same as step S3001. Step S4002 is the same as step S3002.

In step S4003, the control unit 201 determines whether the imaging device 100 can directly communicate with the mounted accessory. If it is determined that the imaging device 100 can directly communicate with the mounted accessory, the processing proceeds to step S4004. If it is determined that the imaging device 100 cannot directly communicate with the mounted accessory, the processing proceeds to step S3003.

For example, if an accessory is mounted on only one of port 1 and port 2 (only one accessory is mounted on each of the two ports), the control unit 201 can determine that the imaging device 100 can directly communicate with the mounted accessory. Alternatively, if an accessory is mounted on both port 1 and port 2 but the communication addresses set for the two accessories are different, the control unit 201 can determine that the imaging device 100 can directly communicate with the mounted accessory.

In step S4004, the control unit 201 appends the capability information (information indicating that the imaging device 100 can directly communicate with the accessory mounted on the port) and the port information to the type information of the mounted accessory.

In step S4005, the communication unit 206 transmits the type information of the mounted accessory to which the capability information and the port information have been appended to the imaging device 100.

In step S4006, the communication unit 206 sets the state of the switch 207 to the ON state so that the imaging device 100 can directly communicate with the mounted accessory.

In step S4007, the communication unit 206 maintains the state of the switch 207 in the ON state. This allows the imaging device 100 and the mounted accessory to communicate directly. In other words, the imaging device 100 and the mounted accessory transmit and receive I2C signals without communication being controlled by the control unit 201. In this case, the imaging device 100 does not transmit a communication command with appended port information.

Steps S3003 to S3007 are the same as the steps with the same names in the flowchart of FIG. 3.

According to the first modified example, the electronic apparatus 200 enables the imaging device 100 and the mounted accessory to directly communicate with each other when the imaging device 100 and the mounted accessory can communicate with each other without controlling the communication between the imaging device 100 and the mounted accessory. As a result, in such cases, communication between the imaging device 100 and the mounted accessory can be made faster.

### Second Modified Example

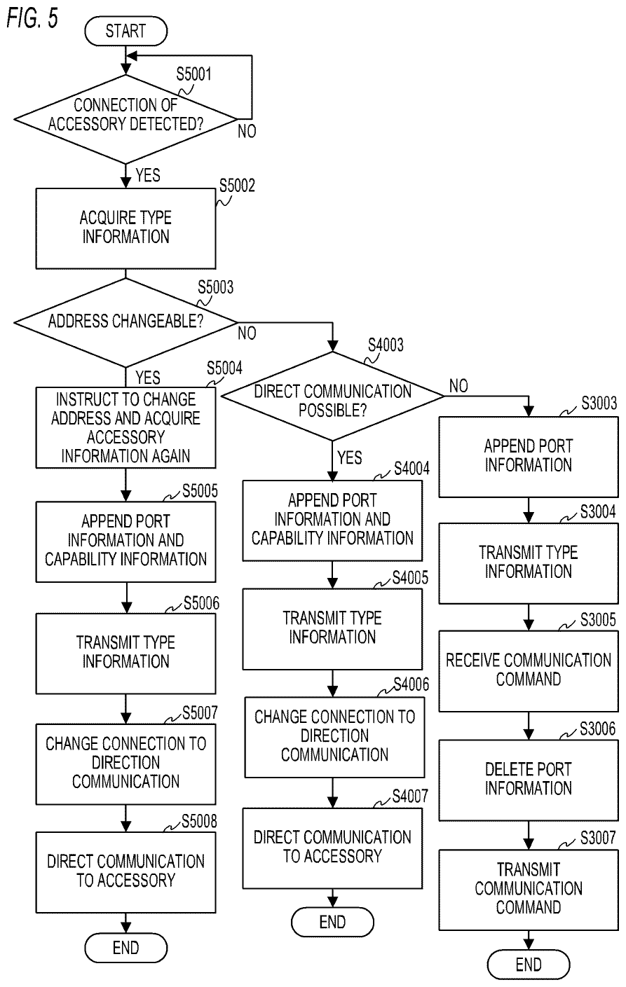

In the second modified example, the control unit 201 changes the communication address of the accessory. The processing of the electronic apparatus 200 according to the second modified example will be described with reference to the flowchart of FIG. 5.

Step S5001 is the same as step S3001. Step S5002 is the same as step S3002.

In step S5003, the control unit 201 determines whether the communication address of the mounted accessory for the imaging device 100 can be changed. If it is determined that the communication address can be changed, the processing proceeds to step S5004. If it is determined that the communication address cannot be changed, the processing proceeds to step S4003. As a method of determining whether the communication address can be changed, a method of determining whether the mounted accessory supports a change of the communication address based on the type information of the mounted accessory may be used.

In step S5004, the control unit 201 instructs the mounted accessory to change the communication address, and then acquires the information of the mounted accessory again. As a method of changing the communication address, a method in which the imaging device 100 specifies a new communication address for the mounted accessory, and a method in which the mounted accessory switches to a pre-stored next communication address (the second or third communication address) may be used.

Steps S4003 to S4007 are the same as those described in the flowchart of FIG. 4. Steps S3003 to S3007 are the same as those described in the flowchart of FIG. 3.

Steps S5005 to S5008 are the same as S4004 to S4007 in the flowchart of FIG. 4.

Note that step S5003 may be executed only when a plurality of accessories are mounted on a plurality of ports and the communication addresses of the plurality of accessories are duplicated. Then, in step S5004, the control unit 201 may instruct at least one of the plurality of accessories to change the communication address to prevent duplication among the communication addresses of the plurality of accessories. In this case, in step S5007, the control unit 201 directly connects the imaging device 100 and the plurality of accessories by turning on the switch 207.

According to the second modified example, the electronic apparatus 200 enables the imaging device 100 and the mounted accessory to directly communicate with each other, provided that the address of the mounted accessory can be changed. As a result, in such cases, communication between the imaging device 100 and the mounted accessory can be made faster.

Further, in the above, the phrase “when A is greater than or equal to B, the processing proceeds to step S1, and when A is less than B, the processing proceeds to step S2” may alternatively be construed as “when A is greater than B, the processing proceeds to step S1, and when A is less than or equal to B, the processing proceeds to step S2.” Conversely, the phrase “when A is greater than B, the processing proceeds to step S1, and when A is less than or equal to B, the processing proceeds to step S2” may alternatively be construed as “when A is greater than or equal to B, the processing proceeds to step S1, and when A is less than B, the processing proceeds to step S2.” Accordingly, unless contradiction arises, the phrase “equal to or greater than A” may be construed as “greater than (higher than; longer than; more than) A,” and the phrase “equal to or less than A” may be construed as “less than (lower than; shorter than; fewer than) A.” Similarly, the phrase “greater than (higher than; longer than; more than) A” may be construed as “equal to or greater than A,” and the phrase “less than (lower than; shorter than; fewer than) A” may be construed as “equal to or less than A.”

Note that the above-described various types of control may be processing that is carried out by one piece of hardware (e.g., processor or circuit), or otherwise. Processing may be shared among a plurality of pieces of hardware (e.g., a plurality of processors, a plurality of circuits, or a combination of one or more processors and one or more circuits), thereby carrying out the control of the entire device.

Also, the above processor is a processor in the broad sense, and includes general-purpose processors and dedicated processors. Examples of general-purpose processors include a central processing unit (CPU), a micro processing unit (MPU), a digital signal processor (DSP), and so forth. Examples of dedicated processors include a graphics processing unit (GPU), an application-specific integrated circuit (ASIC), a programmable logic device (PLD), and so forth. Examples of PLDs include a field-programmable gate array (FPGA), a complex programmable logic device (CPLD), and so forth.

The embodiment described above (including variation examples) is merely an example. Any configurations obtained by suitably modifying or changing some configurations of the embodiment within the scope of the subject matter of the present disclosure are also included in the present disclosure. The present disclosure also includes other configurations obtained by suitably combining various features of the embodiment.

According to the present disclosure, it is possible to allow a device to communicate with each of a plurality of accessories via an electronic apparatus that allows the plurality of accessories to be connected to the device.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-134867, filed Aug. 13, 2024, which is hereby incorporated by reference herein in its entirety.

What is claimed is:

1. An electronic apparatus comprising:
an adapter connectable to an accessory shoe of a first device;
a plurality of accessory shoes on each of which an accessory is mountable, the accessory being capable of being mounted on the accessory shoe of the first device;
a processor; and
a memory storing a program which, when executed by the processor, causes the electronic apparatus to:
execute a connection detection process of detecting that an accessory has been mounted on at least one of the plurality of accessory shoes; and
execute a control process of performing communication control to:
in a case where it is detected that an accessory has been mounted in the connection detection process, transmit, to the first device, information including a type of a mounted accessory which is the accessory mounted on at least any of the plurality of accessory shoes and first port information indicating the accessory shoe on which the mounted accessory is mounted; and
in a case where a communication command to which second port information indicating an accessory shoe to be used for communication is appended is received from the first device, transmit the communication command, from which the second port information is deleted, to the accessory mounted on the accessory shoe indicated by the second port information.

2. The electronic apparatus according to claim 1, wherein in the control process,
it is determined whether communication between the mounted accessory and the first device is possible even in a case where the communication control is not performed; and
in a case where it is determined that communication between the mounted accessory and the first device is possible even in a case where the communication control is not performed, transmission and reception of communication signals is performed between the first device and the mounted accessory without performing the communication control.

3. The electronic apparatus according to claim 2, wherein, in the control process, in a case where only one accessory is mounted on the plurality of accessory shoes, it is determined that communication between the mounted accessory and the first device is possible even in a case where the communication control is not performed.

4. The electronic apparatus according to claim 2, wherein, in the control process,
in a case where a plurality of accessories are mounted on the plurality of accessory shoes and communication addresses of the plurality of accessories are not duplicated, it is determined that communication between the mounted accessory and the first device is possible even in a case where the communication control is not performed.

5. The electronic apparatus according to claim 2, wherein the communication signals are I2C (Inter-Integrated Circuit) signals.

6. The electronic apparatus according to claim 1, wherein
in a case where a plurality of accessories are mounted on the plurality of accessory shoes and communication addresses of the plurality of accessories are duplicated, in the control process, after a control is performed such that the communication addresses of the plurality of accessories are not to be duplicated by instructing at least any of the plurality of accessories to change the communication address, transmission and reception of communication signals is performed between the first device and the mounted accessory without performing the communication control.

7. The electronic apparatus according to claim 1, wherein the first device is an imaging device.

8. An information processing device which is the first device connectable to the electronic apparatus according to claim 1, the information processing device comprising:
a specific adapter configured to be connected to the electronic apparatus, wherein
in a case where communication with the mounted accessory is performed via the electronic apparatus, the specific adapter transmits, to the electronic apparatus, the communication command which is appended with the second port information indicating the accessory shoe on which the mounted accessory is mounted.

9. The information processing device according to claim 8, wherein the specific adapter does not transmit the communication command, to which the second port information is appended, to the electronic apparatus in a case where control is executed such that transmission and reception of communication signals between the first device and the mounted accessory is performed without performing the communication control.

10. A method of controlling an electronic apparatus including an adapter connectable to an accessory shoe of a first device, and a plurality of accessory shoes on each of which an accessory is mountable, the accessory being capable of being mounted on the accessory shoe of the first device, the method comprising:
executing a connection detection process of detecting that an accessory has been mounted on at least one of the plurality of accessory shoes; and
executing a control process of performing communication control to:
in a case where it is detected that an accessory has been mounted in the connection detection process, transmit, to the first device, information including a type of a mounted accessory which is the accessory mounted on at least any of the plurality of accessory shoes and first port information indicating the accessory shoe on which the mounted accessory is mounted; and
in a case where a communication command to which second port information indicating an accessory shoe to be used for communication is appended is received from the first device, transmit the communication command, from which the second port information is deleted, to the accessory mounted on the accessory shoe indicated by the second port information.

11. A non-transitory computer readable medium that stores a program, wherein the program causes a computer to execute a method of controlling an electronic apparatus including an adapter connectable to an accessory shoe of a first device, and a plurality of accessory shoes on each of which an accessory is mountable, the accessory being capable of being mounted on the accessory shoe of the first device, the method comprising:
executing a connection detection process of detecting that an accessory has been mounted on at least one of the plurality of accessory shoes; and
executing a control process of performing communication control to:
in a case where it is detected that an accessory has been mounted in the connection detection process, transmit, to the first device, information including a type of a mounted accessory which is the accessory mounted on at least any of the plurality of accessory shoes and first port information indicating the accessory shoe on which the mounted accessory is mounted; and
in a case where a communication command to which second port information indicating an accessory shoe to be used for communication is appended is received from the first device, transmit the communication command, from which the second port information is deleted, to the accessory mounted on the accessory shoe indicated by the second port information.
